(19) United States
(12) Patent Application Publication
(10) Pub. No.: US 2020/0393068 A1
(43) Pub. Date: Dec. 17, 2020

(54) STRUCTURE FOR MOUNTING GASKET ON BLOCK AND GASKET

(71) Applicant: NIPPON PILLAR PACKING CO., LTD., Osaka-shi (JP)

(72) Inventors: Atsushi NAKANO, Osaka-shi (JP); Toshihide I IDA, Osaka-shi (JP); Tomoyuki KOIKE, Osaka-shi (JP); Tomohiro ADACHI, Osaka-shi (JP)

(73) Assignee: NIPPON PILLAR PACKING CO., LTD., Osaka-shi (JP)

(21) Appl. No.: 16/956,914

(22) PCT Filed: Jan. 15, 2019
(86) PCT No.: PCT/JP2019/000893

§ 371 Date: Jun. 22, 2020

(30) Foreign Application Priority Data
Mar. 13, 2018 (JP) 2018-045021

(51) Int. Cl. F16L 37/02; F16J 15/10

(52) U.S. Cl. CPC F16L 37/025; F16J 15/104; F16J 15/102

(57) ABSTRACT

A structure for mounting a gasket on a block includes a block with a fluid channel and a gasket surrounding an opening of the fluid channel. The gasket has a sealing tip, which is an annular wall made of resin and located radially outside the opening of the fluid channel. The sealing tip is press-fitted in the block and is elastically deformable in its radial direction.

### TECHNICAL FIELD

The invention relates to structures for mounting gaskets on blocks and the gaskets.

A structure for mounting a gasket on a base by using an adhesive is known, for example, as described in Patent Literature 1.

### CITATION LIST

### Patent Literature

Patent Literature 1: JP 2017-025992 A

### SUMMARY OF INVENTION

A structure for mounting a gasket on a block is known, in which the block includes a fluid channel to allow fluid to pass therein. To the block, the gasket is mounted such that an axial side of its annular shape is press-fitted around an opening of the fluid channel of the block.

When the gasket of the structure is manufactured by resin molding, an axial side of the gasket often fails to be formed in a convex shape that can be smoothly accepted by a concave portion of the block inside which the axial side of the gasket is to be press-fitted.

In contrast to the concave portion of the block having a circular-cylindrical shape, the axial side of the gasket often fails to have a circular-cylindrical shape, but generally has an elliptic-cylindrical shape. Such a circular-cylindrical shape is necessary for the axial side of the gasket to be smoothly accepted by the concave portion of the block.

The main reason why the axial side of the gasket fails to have a circular-cylindrical shape seems to be contraction of resin material during resin molding of the axial side of the gasket. Even when the axial side of the gasket fails to have a circular-cylindrical shape, forcibly press-fitting the axial side of the gasket into the concave portion of the block can connect the block with another block.

However, difference in shape between the concave portion of the block and the axial side of the gasket causes the axial side of the gasket to insufficiently fit the concave portion of the block. This can result in a region of reduced adhesion, thus preventing the gasket and the block from achieving high sealing performance.

In view of the above-mentioned problems, the invention is devised. An object of the invention is to enhance sealing performance of a structure for mounting a gasket on a block.

A structure for mounting a gasket on a block according to the invention includes a block with a fluid channel and a gasket surrounding an opening of the fluid channel. The gasket includes an annular wall made of resin radially outside the opening of the fluid channel. The annular wall is press-fitted in the block and is elastically deformable in its radial direction.

The structure enables the block to elastically deform the annular wall of the gasket in its radial direction when the annular wall is press-fitted in the block. This can cause the annular wall to be more flexible to the block. After press-fitted, the annular wall can press substantially the whole periphery of the block by a substantially uniform force. This enables the gasket mounted on the block to achieve higher sealing performance.

The annular wall may be 0.165 mm to 5.4 mm in thickness.

The annular wall may be 1.5 mm to 15 mm in axial length.

The annular wall may have an outer diameter of 5 mm to 60 mm. An outer diameter a of the annular wall and a radial thickness b thereof may fall within a range defined by the following equations (1) and (2):

b=0.065a+1.5, (1)

b=0.033a. (2)

The annular wall may be 1.5 mm to 15 mm in axial length. An axial length c of the annular wall and the thickness b thereof may fall within a range defined by the following equations (3) and (4):

b=0.379c−0.285, (3)

b=0.31c−0.3. (4)

The annular wall may be made of a material with a modulus of elasticity of 200 MPa to 3200 MPa.

A gasket according to the invention is to be connected to an opening of a block including a fluid channel. The gasket includes an annular wall made of resin radially outside the opening of the fluid channel. The annular wall is press-fitted in the block and is elastically deformable in its radial direction.

The invention can enhance the sealing performance of the structure for mounting the gasket on the block.

### BRIEF DESCRIPTION OF DRAWINGS

FIG. 1 is a cross-sectional view of a structure for mounting a gasket on a block according to an embodiment of the invention;

FIG. 2 is a partially enlarged view of FIG. 1;

FIG. 3 is a perspective view of the gasket of FIG. 1;

FIG. 4 is a view of the gasket of FIG. 1 from its axial direction;

FIG. 5 is a cross-sectional view taken along the lines I-I of FIG. 4;

FIG. 6 is a partial cross-sectional view of a block and a gasket separated from each other;

FIG. 7 is a graph of the relationship between the outer diameter and thickness of an outer periphery of an annular wall of the gasket of FIG. 1; and

FIG. 8 is a graph of the relationship between the axial length and thickness of the outer periphery of the annular wall of the gasket of FIG. 1.

### DESCRIPTION OF EMBODIMENTS

A structure for mounting a gasket on a block according to the invention can be used in fields of, for example, semiconductors, liquid crystals, organic electroluminescent devices, medical and pharmaceutical supplies, or automobiles.

The structure for mounting a gasket on a block according to the invention can also be used in fields other than the above-listed ones, for many purposes.

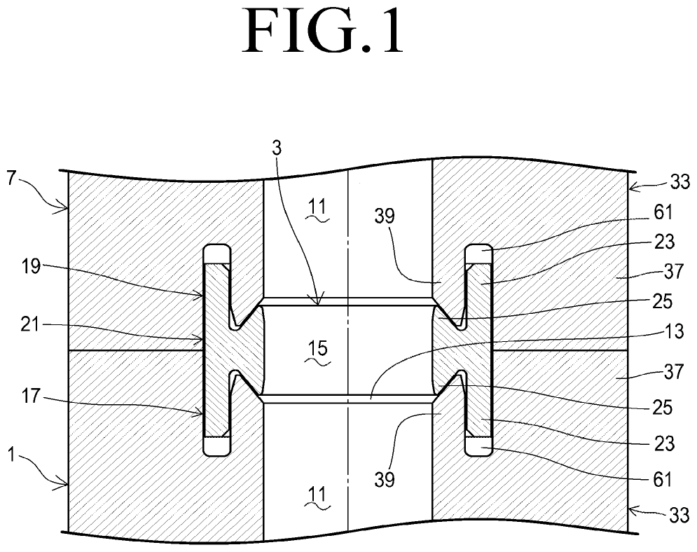

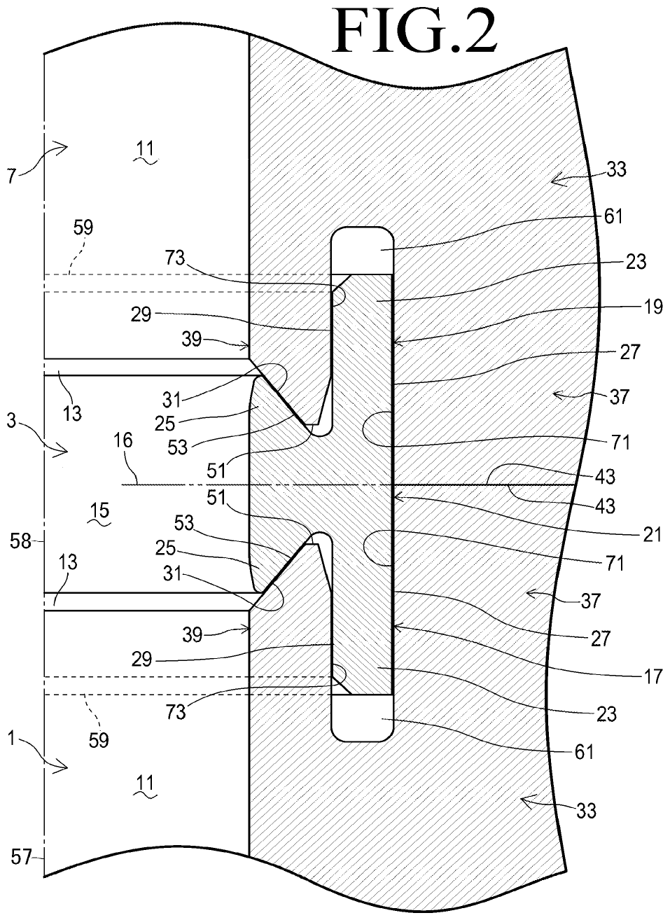

FIG. 1 is a cross-sectional view of the structure for mounting a gasket on a block according to an embodiment of the invention. FIG. 2 is a partially enlarged view of FIG. 1.

As shown in FIGS. 1 and 2, the structure includes a block 1 and a gasket 3. The gasket 3 has an annular shape whose first end is mounted to the block 1.

When mounted on the block 1, the gasket 3 surrounds an opening 13 at one end of a first fluid channel 11 of the block 1. The gasket 3 is press-fitted in, i.e. pressed on and engaged with the rim of the opening 13 of the first fluid channel 11 of the block 1.

With the gasket 3, the block 1 is coupled to another adjacent block 7. A second end of the gasket 3 is mounted to the other block 7. The portion of the other block 7 receiving the second end of the gasket 3 has a structure similar to that of the portion of the block 1 receiving the first end of the gasket 3. The gasket 3 is thus placed between the blocks 1 and 7.

The embodiment adopts a structure for mounting the gasket 3 on the block 1 as described below. The structure is similar to that for mounting the gasket 3 on the other block 7.

Blocks according to the invention mean gasket-mounting portions of regulators, pressure gauges, valves, flowmeters, resin tubes.

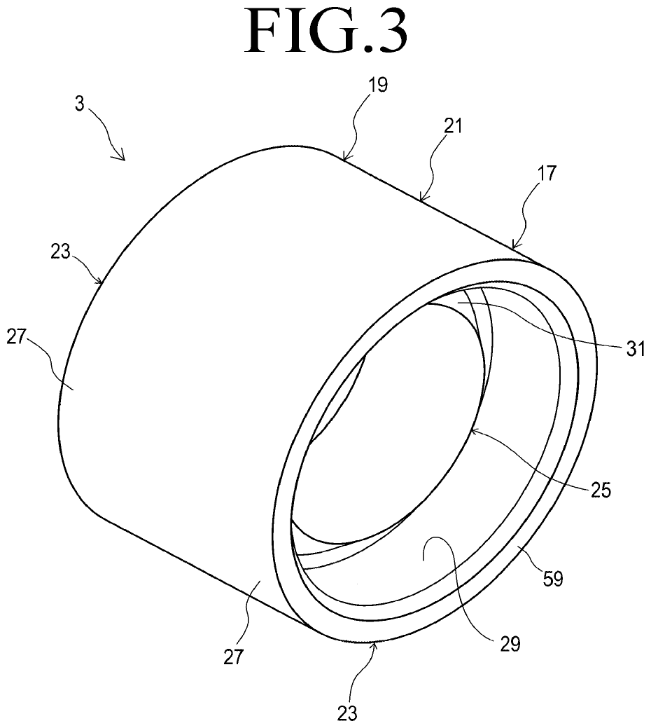

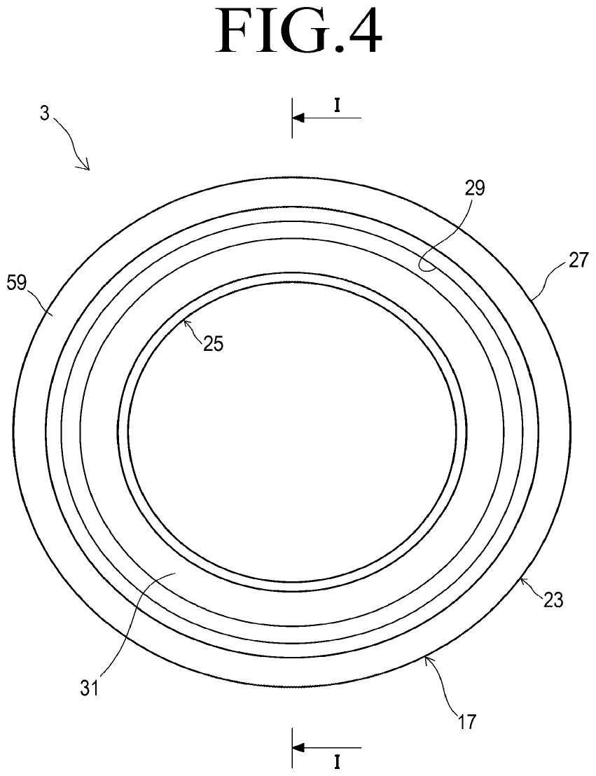

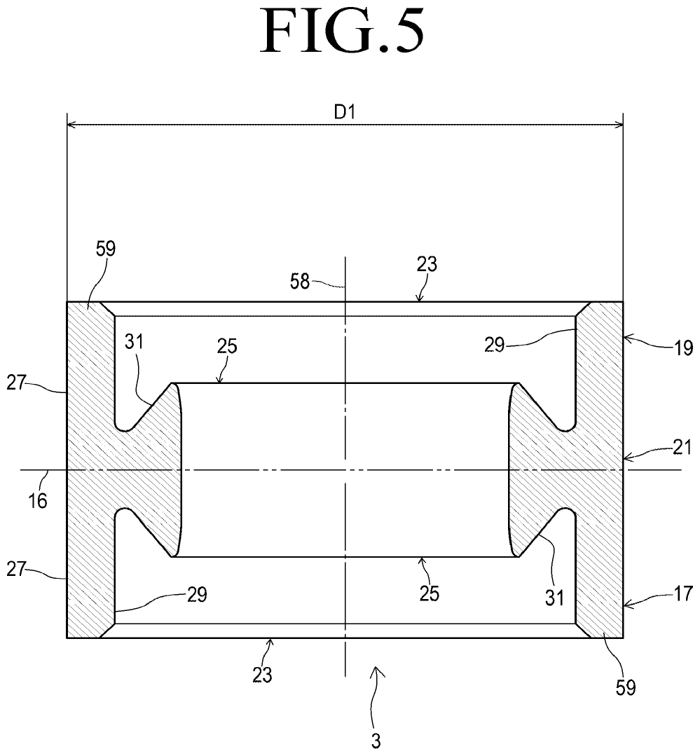

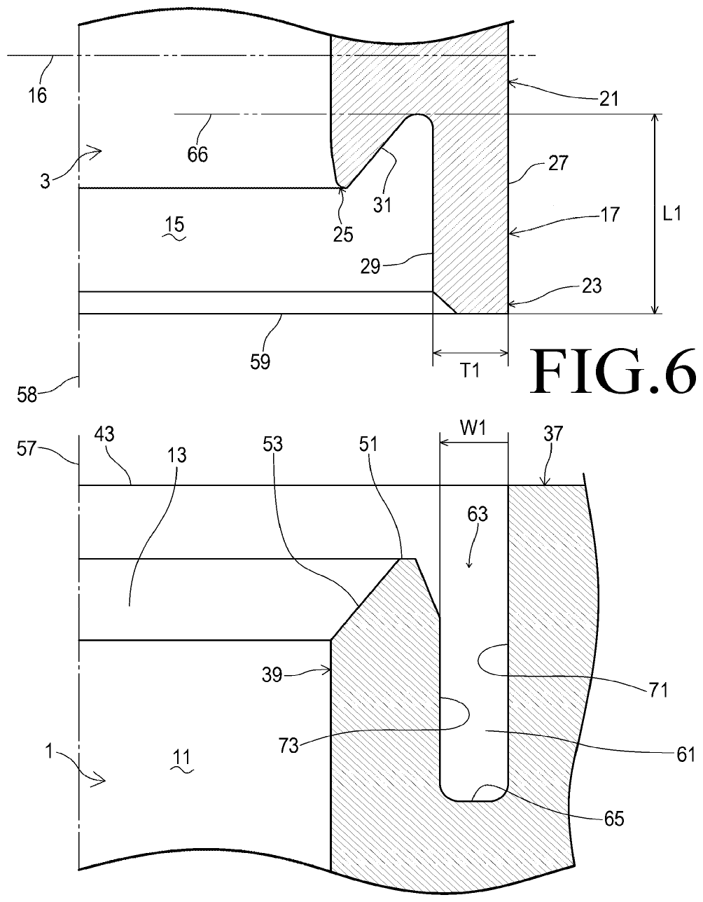

FIG. 3 is a perspective view of the gasket 3. FIG. 4 is a view of the gasket 3 from its axial direction. FIG. 5 is a cross-sectional view taken along the lines I-I of FIG. 4. FIG. 6 is a partial cross-sectional view of the block 1 and the gasket 3 separated from each other.

As shown in FIGS. 3 to 6, the gasket 3 has a second fluid channel 15, which is a through hole penetrating the gasket 3 in its axial direction and being connected to the first fluid channel 11 through its opening 13.

The gasket 3 has a shape symmetric with respect to a central surface 16 perpendicular to the axial direction of the gasket 3. This enables the gasket 3 to be mounted on the other block 7 with a structure similar to that allows the gasket 3 to be mounted on the block 1.

The gasket 3 has a cylindrical shape. The gasket 3 has a first axial side 17 and a second axial side 19 opposite to each other and an axially intermediate portion 21 between the first axial side 17 and the second axial side 19.

Suppose that the axial direction of the gasket 3 is a vertical direction. The first axial side 17, i.e. a lower side of the gasket 3 is mounted to the block 1. The second axial side 19, i.e. an upper side of the gasket 3 is mounted to the other block 7.

The first axial side 17 of the gasket 3 has an annular sealing tip 23 and an annular tapered protrusion 25. The sealing tip 23 is an annular wall made of resin, substantially coaxial with the opening 13, and located around the tapered protrusion 25.

The sealing tip 23 is formed in a cylindrical shape with substantially constant radial thickness. The sealing tip 23 protrudes from the axially intermediate portion 21 of the gasket 3 toward a first axial direction of the gasket 3, i.e. downward.

An outer periphery of the sealing tip 23 is an outer periphery of the first axial side 17 of the gasket 3 and has an outer contact surface 27. An inner periphery of the sealing tip 23 has an inner contact surface 29.

The tapered protrusion 25 is formed in a cylindrical shape with varying radial thickness. The tapered protrusion 25 protrudes from the axially intermediate portion 21 of the gasket 3 toward the same direction as the sealing tip 23, i.e. toward the first axial direction of the gasket 3.

The tapered protrusion 25 is placed at a distance from the sealing tip 23 radially inward. The tapered protrusion 25 protrudes from the axially intermediate portion 21 of the gasket 3 by a length shorter than the sealing tip 23.

The tapered protrusion 25 is formed such that its outer diameter gradually reduces with increased distances from the axially intermediate portion 21 of the gasket 3 in the first axial direction. This provides an outer periphery of the tapered protrusion 25 with an outer contact surface 31 inclined radially inward.

The opening 13 of the first fluid channel 11 inside the block 1 is exposed to the outside of the block 1 and is connected to the second fluid channel 15 inside the gasket 3 when the gasket 3 is mounted on the block 1.

The first fluid channel 11 extends in an axial direction of an annular gasket-mounting portion 33 of the block 1, i.e. in a vertical direction. The opening 13 of the first fluid channel 11 is located at a second axial end, i.e. an upper end of the gasket-mounting portion 33.

The gasket-mounting portion 33 allows the gasket 3 to surround the opening 13 of the first fluid channel 11. A second axial side, i.e. an upper side of the gasket-mounting portion 33 can be pressed on and engaged with the gasket 3.

The gasket-mounting portion 33 has an outer diameter larger than the first axial side 17 of the gasket 3, i.e. the sealing tip 23. The gasket-mounting portion 33 has an inner diameter substantially the same as the first axial side 17 of the gasket 3.

The gasket-mounting portion 33 has an annular outer periphery 37 and an annular inner periphery 39 radially outside the opening 13 of the first fluid channel 11.

More accurately, the inner periphery 39 is located radially outside the opening 13 of the first fluid channel 11, i.e. around the opening 13, and the outer periphery 37 is located radially outside the inner periphery 39, i.e. around the inner periphery 39.

There is a groove 61 between the outer periphery 37 and the inner periphery 39 of the block 1 as described later. Inside the groove 61, the sealing tip 23 of the gasket 3 is press-fitted.

When the sealing tip 23 is press-fitted inside the groove 61, the outer periphery 37 is located radially outside the sealing tip 23, and the inner periphery 39 is located radially inside the sealing tip 23.

The outer periphery 37 of the gasket-mounting portion 33 has a shape that can receive the sealing tip 23 therein. That is, the outer periphery 37 has an opening on a side near the first axial side 17 of the gasket 3, esp. the sealing tip 23.

The outer periphery 37 has a cylindrical shape with a substantially constant radial thickness. The outer periphery 37 has an inner diameter almost the same as the outer diameter of the sealing tip 23, i.e. the outer diameter of the gasket 3.

As shown in FIG. 2, the outer periphery 37 has a substantially flat end surface 43, which faces an end surface 43 of the outer periphery 37 of the other block 7 coupled to the block 1 when the gasket 3 surrounds the opening 13 of the first fluid channel 11.

The inner periphery 39 of the gasket-mounting portion 33 is received by the sealing tip 23. The inner periphery 39 has an opening on a side near the first axial side 17 of the gasket 3, esp. the tapered protrusion 25.

The inner periphery 39 has a cylindrical shape with varying radial thickness. In particular, the inner periphery 39 has an outer diameter larger than the inner diameter of the sealing tip 23 and an inner diameter substantially the same as the inner diameter of the tapered protrusion 25.

The inner periphery 39 extends in the same direction as the outer periphery 37, i.e. in a vertical direction. The inner periphery 39 has a substantially flat end surface 51, which is located radially outside the opening 13 of the first fluid channel 11 and radially inside the end surface 43 of the outer periphery 37.

The inner periphery 39 of the gasket-mounting portion 33 is disposed at a distance from the outer periphery 37 thereof radially inward. The inner periphery 39 is surrounded by the outer periphery 37 and substantially coaxial with the outer periphery 37.

The inner periphery 39 has a tapered inner contact surface 53 between the lower end and the upper end, i.e. the end surface 51 of the inner periphery 39. The inner diameter of the inner contact surface 53 gradually increases with increased distance from the lower end of the inner periphery 39 toward the second axial side, i.e. upward.

The inner contact surface 53 of the inner periphery 39 abuts the outer contact surface 31 of the tapered protrusion 25. The inner contact surface 53 is inclined at an angle appropriate to an angle of the outer contact surface 31 such that the inner contact surface 53 can be pressed on the outer contact surface 31.

The angle at which the inner contact surface 53 is inclined from the axis 57 of the first fluid channel 11, i.e. the axis of the annular inner wall 39, differs from the angle at which the outer contact surface 31 is inclined from the axis 58 of the second fluid channel 15, i.e. the axis of the tapered protrusion 25.

For example, the angle at which the inner contact surface 53 is inclined from the axis 57 of the first fluid channel 11 is larger than the angle at which the outer contact surface 31 is inclined from the axis 58 of the second fluid channel 15.

Alternatively, the angle of the inner contact surface 53 may be substantially the same as or smaller than the angle of the outer contact surface 31.

Inside a space between the outer periphery 37 and the inner periphery 39 of the gasket-mounting portion 33, an end 59 of the sealing tip 23 of the gasket 3 is press-fitted.

The groove 61 is located between the outer periphery 37 and the inner periphery 39 of the gasket-mounting portion 33. The groove 61 has a bottom and an opening that faces toward the same direction as the openings of the outer periphery 37 and the inner periphery 39, i.e. upward.

The opening 63 of the groove 61 is located on the second axial side of the inner periphery 39, i.e. on its upper side. A bottom 65 of the groove 61 is located on the first axial side of the inner periphery 39, i.e. on its lower side. The groove 61 allows the end 59 of the sealing tip 23 to pass through the opening 63.

The groove 61 has a ring shape extending along the whole circumference of the outer periphery 37 and the inner periphery 39. The width W1 of the groove 61 is substantially constant in its circumferential and radial directions.

As shown in FIG. 6, the width W1 of the groove 61 is smaller than the thickness T1 of the sealing tip 23. The width W1 can be appropriately adjusted depending on the sealing tip 23 such that the groove 61 allows the sealing tip 23 to be press-fitted therein.

The width W1 of the groove 61 is substantially constant within almost all the axial range of the outer periphery 37 and the inner periphery 39. The width W1 of the groove 61 is defined as a radial length of each segment of the groove 61.

By way of exception, inside the opening 63 of the groove 61, a portion nearer to the second axial side of the inner periphery 39 has a larger width W1 since the radially outside portion of the inner periphery 39 is tapered near the end surface 51.

The gasket-mounting portion 33 of the block 1, i.e. the outer periphery 37 and the inner periphery 39 can elastically deform the sealing tip 23 press-fitted in the block 1. Detail will be described later.

The gasket-mounting portion 33 according to the embodiment is made of, for example, fluororesin, which is thermoplastic resin such as perfluoroalkoxy alkane (PFA) or polytetrafluoroethylene (PTFE). As usage, the gasket-mounting portion 33 may be made of, for example, polypropylene (PP), high-density polyethylene (HDPE), low-density polyethylene (LDPE), polyoxymethylene (POM), or elastomer (i.e. rubber).

The sealing tip 23 of the gasket 3 can be press-fitted in the block 1, i.e. inside the groove 61 between the outer periphery 37 and the inner periphery 39 of the gasket-mounting portion 33, and be elastically deformed in its radial direction.

When press-fitted inside the groove 61 of the gasket-mounting portion 33 of the block 1, the sealing tip 23 of the gasket 3 is elastically deformed by at least one of the outer periphery 37 and the inner periphery 39 of the gasket-mounting portion 33.

The sealing tip 23 is elastically deformed in its radial direction such that some segments move separately from other segments along the profile of the space between the outer periphery 37 and the inner periphery 39, i.e. the profile of the groove 61.

Suppose that the sealing tip 23 fails to have a circular-cylindrical shape in contrast to the groove 61 in a circular-cylindrical shape. In this case, some segments of the sealing tip 23 can be elastically deformed radially outward and other segments can be elastically deformed radially inward to fit the profile of the groove 61.

The thickness T1 of the sealing tip 23, i.e. the annular wall of the gasket 3, cf. FIG. 6, falls within the range from 0.165 mm to 5.4 mm. The thickness T1 of the sealing tip 23 means the radial length of each segment of the sealing tip 23.

The thickness T1 of the sealing tip 23 is larger than the width W1 of the groove 61 such that the sealing tip 23 can be press-fitted inside the groove 61. The thickness T1 of the sealing tip 23 is substantially constant within almost all the axial range of the sealing tip 23 press-fitted inside the groove 61.

The axial length L1 of the sealing tip 23, cf. FIG. 6, falls within the range of 1.5 mm to 15 mm. The axial length L1 of the sealing tip 23 means a length by which the sealing tip 23 protrudes from a reference surface 66 shown in FIG. 6.

The reference surface 66 is a plane perpendicular to the axial direction of the sealing tip 23. The reference surface 66 extends along the boundary between the first axial side 17 of the gasket 3 (i.e. the sealing tip 23 and the tapered protrusion 25) and the axially intermediate portion 21.

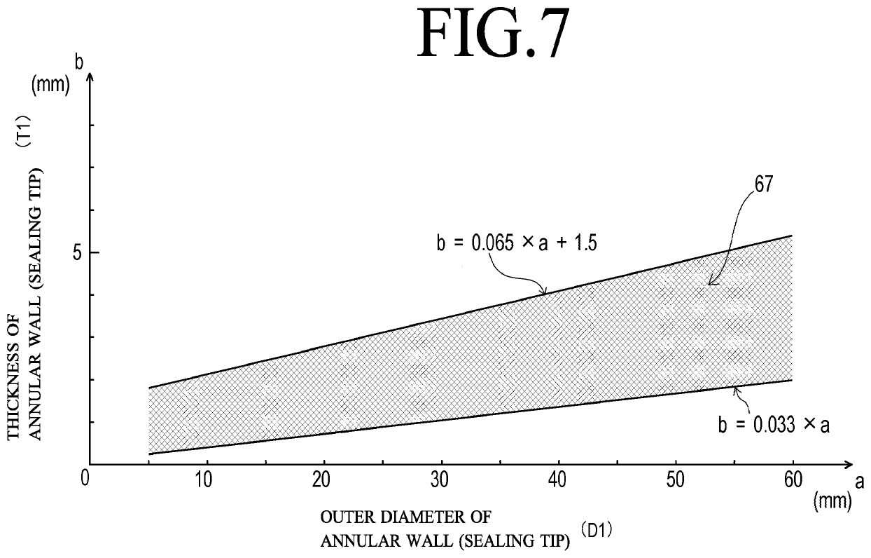

The outer diameter D1 of the sealing tip 23 falls within the range from 5 mm to 60 mm. Let a be the outer diameter D1 of the sealing tip 23 and b be the thickness T1 thereof. The outer diameter D1 and thickness T1 of the sealing tip 23 fall within a range defined by the following equations (1) and (2), i.e. the range 67 shown in FIG. 7:

b=0.065a+1.5, (1)

b=0.033a. (2)

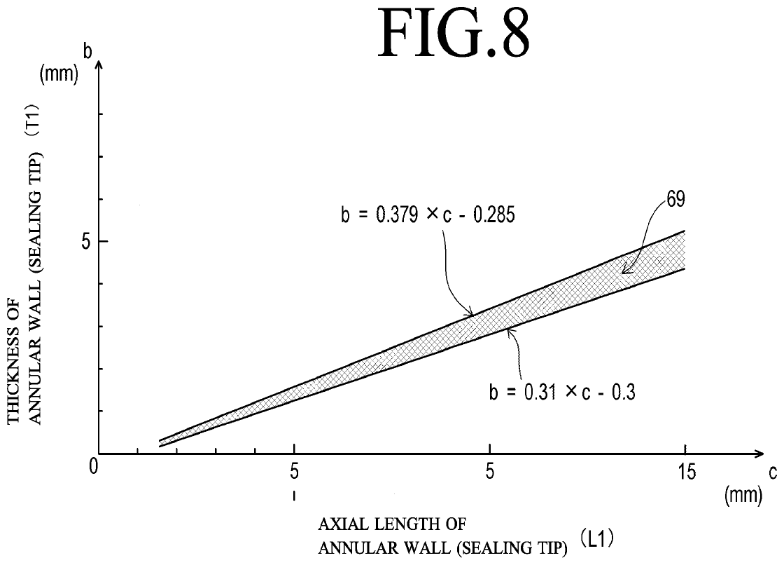

As described above, the axial length L1 of the sealing tip 23 falls within the range of 1.5 mm to 15 mm. Let c be the axial length L1 of the sealing tip 23. The thickness T1 and axial length L1 of the sealing tip 23 fall within a range defined by the following equations (3) and (4), i.e. the range 69 shown in FIG. 8:

b=0.379c−0.285, (3)

b=0.31c−0.3. (4)

The sealing tip 23 is made of resin material with a modulus of elasticity of 200 MPa to 3200 MPa. These values of the modulus of elasticity are measured by the method defined in JIS K 7161 or ASTM D638.

Preferably, the sealing tip 23 is made of resin material with a modulus of elasticity of 300 MPa to 2600 MPa, more preferably, with a modulus of elasticity of 310 MPa to 600 MPa.

The sealing tip 23 can be made of fluororesin, which is thermoplastic resin such as PFA or PTFE. As usage, the sealing tip 23 can be made of PP, HDPE, LDPE, or POM instead of fluororesin.

The portion of the block 1 that allows the sealing tip 23 to be press-fitted therein, i.e. the groove 61 between the outer periphery 37 and the inner periphery 39, has a size that can be appropriately adjusted depending on the size, i.e. thickness, etc., of the sealing tip 23.

The above-described structure enables the sealing tip 23 on the first axial side 17 of the gasket 3 to be press-fitted between the outer periphery 37 and the inner periphery 39, i.e. inside the groove 61, and thus, enables the gasket 3 to be mounted on the block 1. Similarly, the structure enables the sealing tip 23 on the second axial side 19 of the gasket 3 to be press-fitted in the other block 7, and thus, enables the gasket 3 to be mounted on the other block 7. This can result in the coupling between the block 1 and the other block 7.

When mounted on the block 1, the gasket 3 can either press the outer contact surface 27 of the sealing tip 23 onto the inner contact surface 71 of the outer periphery 37 of the block 1 or press the inner contact surface 29 of the sealing tip 23 onto an outer contact surface 73 of the inner periphery 39 of the block 1. In addition, the coupling between the block 1 and the other block 7 can cause the outer contact surface 31 of the tapered protrusion 25 of the gasket 3 to be pressed onto the inner contact surface 53 of the inner periphery 39.

As a result, the structure for mounting the gasket 3 on the block 1 can exert a radial sealing force between the sealing tip 23 and at least one of the outer periphery 37 and the inner periphery 39 of the block 1 to seal the gap therebetween. In addition, the structure can exert an axial sealing force between the tapered protrusion 25 and the inner periphery 39 to seal the gap therebetween.

When the sealing tip 23 is press-fitted in the block 1, i.e. inside the groove 61 between the outer periphery 37 and the inner periphery 39, the structure enables the block 1, i.e. the outer periphery 37 and the inner periphery 39 to elastically deform the sealing tip 23 in its radial direction to fit the profile of the block 1, i.e. the groove 61 between the outer periphery 37 and the inner periphery 39. This enables the sealing tip 23 to change its shape flexibly to the profile of the block 1, i.e. the groove 61.

Even if there is a large difference in radial shape between the sealing tip 23 and the groove 61, the outer periphery 37 and the inner periphery 39 can elastically deform the sealing tip 23 in its radial direction to cause the radial shape of the sealing tip 23 to fit the radial shape of the groove 61. This enables the sealing tip 23 to change its shape flexibly to the profile of the outer periphery 37 and the inner periphery 39.

As a result, the sealing tip 23 can be smoothly press-fitted in the block 1, i.e. inside the groove 61 between the outer periphery 37 and the inner periphery 39. After that, the sealing tip 23 can press substantially the whole periphery of at least one of the outer periphery 37 and the inner periphery 39 by a substantially uniform force. This enables the structure for mounting the gasket 3 on the block 1 to achieve higher sealing performance by using the sealing tip 23.

The gasket 3 according the embodiment of the invention is mounted to the block 1 whose gasket-mounting portion 33 has the outer periphery 37 and the inner periphery 39. This is not the limited case for a gasket according to the invention. The gasket can be mounted on a block whose gasket-mounting portion has only one of the outer periphery and the inner periphery.

An annular wall of a gasket according to the invention only has to be at least partially press-fitted in a block. In the above-described embodiment, the sealing tip 23 serving as the annular wall of the gasket 3 only has to be at least partially press-fitted in the block 1, i.e. inside the groove 61 between the outer periphery 37 and the inner periphery 39.

In view of the above-described teaching, it is obvious that the invention has many variations and modifications. Accordingly, it should be understood that the invention can be embodied in manners other than the embodiments described in this specification within the scope of the attached claims.

### DESCRIPTION OF REFERENCE SYMBOLS

1 block, 3 gasket, 11 first fluid channel, i.e. fluid channel in block, 13 opening of first fluid channel, 23 sealing tip, i.e. annular wall of gasket, D1 outer diameter of gasket, L1 axial length of sealing tip, T1 thickness of sealing tip.

1. A structure for mounting a gasket on a block, comprising:
a block including a fluid channel; and
a gasket surrounding an opening of the fluid channel and including an annular wall made of resin radially outside the opening of the fluid channel, wherein
the annular wall is press-fitted in the block and is elastically deformable in its radial direction.

2. The structure according to claim 1, wherein the annular wall is 0.165 mm to 5.4 mm in thickness.

3. The structure according to claim 1, wherein the annular wall is 1.5 mm to 15 mm in axial length.

4. The structure according to claim 1, wherein
the annular wall has an outer diameter of 5 mm to 60 mm, and
an outer diameter a of the annular wall and a radial thickness b thereof fall within a range defined by the following equations (1) and (2):
b=0.065a+15, (1)
b=0.033a. (2)

5. The structure according to claim 1, wherein
the annular wall is 1.5 mm to 15 mm in axial length, and
an axial length c of the annular wall and the thickness b thereof fall within a range defined by the following equations (3) and (4):
b=0.379c−0.285, (3)
b=0.31c−0.3. (4)

6. The structure according to claim 1, wherein the annular wall is made of a material with a modulus of elasticity of 200 MPa to 3200 MPa.

7. A gasket to be connected to an opening of a block with a fluid channel, comprising an annular wall made of resin radially outside the opening of the fluid channel, wherein
the annular wall is press-fitted in the block and is elastically deformable in its radial direction.
